(19) United States
(12) Patent Application Publication
(10) Pub. No.: US 2005/0173345 A1
(43) Pub. Date: Aug. 11, 2005

(54) Acid tolerant polymeric membrane and process for the recovery of acid using polymeric membranes

(76) Inventors: Bhupender S. Minhas, Bridgewater, NJ (US); Dennis G. Peiffer, Annandale, NJ (US); David C. Dalrymple, Bloomsbury, NJ (US)

Correspondence Address: EXXONMOBIL RESEARCH AND ENGINEERING COMPANY, P.O. BOX 900, 1545 ROUTE 22 EAST, ANNANDALE, NJ, 08801-0900, US

(21) Appl. No.: 10/947,019

(22) Filed: Sep. 22, 2004

Related U.S. Application Data
(63) Continuation-in-part of application No. 10/773,789, filed on Feb. 6, 2004.

(51) Int. Cl. B01D 61/00

(52) U.S. Cl. 210/650; 210/651; 210/500.27; 210/490; 210/500.42

(57) ABSTRACT

A crosslinked polymeric polyvinyl sulfate membrane or crosslinked copolymer polyvinyl sulfate and polyvinyl alcohol membrane, suitable for use in an acid environment, and its use for recovering acid from a feed mixture comprising acid, hydrocarbons and water, the method comprising: processing said mixture using a first polymeric membrane to form a first retentate containing a substantially greater concentration of hydrocarbons than said feed mixture and a first permeate containing a substantially greater concentration of acid and water than said mixture, said first polymeric membrane being selectively permeable to the acid and water over the hydrocarbons found in the mixture, and recovering the first permeate; said first permeate can be processed further using a second water reduction mean to form a first stream containing a substantially greater concentration of acid than said first permeate and a second stream containing a substantially greater concentration of water than said first permeate, said water reduction step may be a second polymeric membrane being selectively permeable to the water over the acid in said first permeate; and recovering said second stream or retentate.

This application is a Continuation-in-Part of U.S. Ser. No. 10/773,789 filed Feb. 6, 2004.

### FIELD OF THE INVENTION

The present invention relates generally to polymeric membranes for separating acid from acid mixtures. More particularly, it relates to particularly adapted polymeric membranes and their use in separating and recovering acids, including sulfuric acid from waste acid mixtures or streams. These streams may comprise acid, and any combination of acid and hydrocarbons and/or water and other “contaminants”, using polymeric membranes.

### BACKGROUND OF THE INVENTION

Numerous industrial processes use acids in their processing that contaminate the acid with process by-products in waste. These contaminated acids are commonly referred to as “spent acid”. Industrial chemical and petroleum processes are prime examples. Many of these processes require purification or regeneration of the process acid to remove impurities, which often require costly processing. Handling spent acid also raises safety and environmental concerns. Accordingly, there is ample need for a separation process to efficiently and effectively remove impurities from process contaminated acids to restore the acid to or near its original process specification. It would also be beneficial if that process could be deployed “in situ” with the process that produced the spent acid. The present invention is directed to a polymeric membrane that is suitable for acid-contaminated separation and its use in “regenerating” process acids. The polymeric membrane withstands the acid environment and preferentially diffuses the acid over the retentate contaminant. The process can be practical “in-situ” with common petroleum and petrochemical processes. Though particularly described hereinafter in relation to use in a petroleum processing stream, the polymeric membrane has application to varied acid/liquid separations.

Acids are widely used in industrial chemical and petroleum refining applications that require acid “regeneration,” which generally means removal of contaminants (including often water) from the process acid to restore the acid to, or near to, its original process specification or requirements. An exemplary acid use to illustrate the present invention is sulfuric acid, which is used in a number of petrochemical and petroleum refining processes.

Sulfuric acid is widely used in industrial chemical and petroleum refining processes. Depending on the use, commercial “fresh” acid is typically supplied in strengths of 70-99.5 wt % sulfuric acid with the remainder typically being water. Many uses generate a waste or spent acid stream containing organic hydrocarbon materials. This spent acid stream is typically reprocessed to remove the organic material. Incineration and reconstitution of the sulfuric acid is conventionally used to remove the organic material.

An exemplary petroleum processing use of sulfuric acid is as a catalyst for alkylation processes. In a typical alkylation process the relatively high purity, concentrated sulfuric acid becomes diluted or contaminated with water and organic hydrocarbon materials commonly referred to as acid soluble oil (ASO). When sufficiently diluted or contaminated, the catalytic activity of the acid degrades. Spent sulfuric acid from the alkylation process can be regenerated but at a considerable cost using existing methods.

Conventional methods for spent acid regeneration involve generally combustion of the spent acid to form sulfur dioxide, conversion of the sulfur dioxide to sulfur trioxide, and absorption of the sulfur trioxide in water. While this technology is widely used to produce high strength acid (>98 wt % H₂SO₄), it is capital intensive. Thus, it is usually more economical for low volume users of sulfuric acid to transfer spent sulfuric acid by various means such as rail, truck, ship, or pipeline to a central regeneration facility rather than construct their own facilities for acid regeneration. Freight costs can be a significant part of the total costs for regenerating spent acid.

Sulfuric acid can also be concentrated from about 70 wt % H₂SO₄ to about 85 wt % or about 96 wt % sulfuric acid by using evaporation with one or two stages. The evaporation method is highly energy intensive as the acid/water mixture must be heated to a high temperature to vaporize the water. It also requires special materials such as glass lined vessels and tantalum heaters to prevent corrosion. An improved, less expensive method for regenerating spent sulfuric acid is needed.

### SUMMARY OF THE INVENTION

The present invention, relates generally to an improved polymeric membrane and its use in regenerating spent acid. One embodiment of the present invention relates to particularly adapted crosslinked polymer membranes that are capable of withstanding an acid environment and its use in a method for recovering an acid such as sulfuric acid from a feed mixture comprising acid, hydrocarbons and water. The method comprises processing said mixture using a the polymeric membrane to form a first retentate containing a substantially greater concentration of hydrocarbons than the feed mixture and a first permeate containing a substantially greater concentration of acid and water than said feed mixture. In another embodiment, the method comprises processing the first permeate using a second polymeric membrane to form a second retentate containing a substantially greater concentration of acid than the first permeate and a second permeate containing a substantially greater concentration of water than the first permeate, and recovering said second retentate. A further embodiment includes conventional processing of the first retentate.

Yet another embodiment of the present invention relates to an improved alkylation process. The alkylation process comprises contacting an olefin mixture with an isoparaffin mixture in the presence of a liquid acid catalyst under conditions effective to produce an alkylate product. The liquid acid catalyst can be any liquid acid suitable for catalyzing the alkylation reaction such as sulfuric acid. The spent acid which is a mixture comprising sulfuric acid, hydrocarbons and water is recovered and processed using a first polymeric membrane to form a first retentate containing a substantially greater concentration of hydrocarbons than said spent sulfuric acid mixture and a first permeate containing a substantially greater concentration of sulfuric acid and water than the spent acid mixture. In one embodiment, the first permeate is recycled back to the alkylation reactor. In a second embodiment, the first permeate is optionally further processed to reduce its water content. Optimally, this further processing includes evaporation under vacuum, adding acid anhydride, adding oleum, or using a second polymeric membrane to reduce water content. Each further processing will form a first stream containing a substantially greater concentration of sulfuric acid than said first permeate and a second stream containing a substantially greater concentration of water than said first permeate. The first stream is recovered and recycled to the alkylation process.

### BRIEF DESCRIPTION OF THE DRAWINGS

FIGS. 1 to 5 are simplified schematics of different embodiments of the present invention.

FIG. 6 is a FTIR spectra of a Teflon membrane support having a nominal pore size of 0.2 microns.

FIG. 7 shows FTIR spectra of used and unused PVA membranes.

FIG. 8 is a simplified schematic of a membrane testing system.

FIG. 9 shows the relative flux of an inventive PVA membrane.

FIG. 10 shows the amount of ASO in wt % in the permeate as a function of run time for an inventive PVA membrane.

FIG. 11 shows the amount of ASO in wt % in the membrane test cell feed as a function of run time for an inventive PVA membrane.

### DETAILED DESCRIPTION OF THE INVENTION

### Membranes and Membrane/Support

The present invention relates generally to polymeric membranes for separating acid from acid mixtures. More particularly, it relates to particularly adapted polymeric membranes and their use in separating and recovering acids, including sulfuric acid from waste acid mixtures or streams. These streams may comprise acid, and any combination of acid and hydrocarbons and/or water and other “contaminants”, using polymeric membranes. The membranes of the present invention comprise crosslinked polymer membranes. More particularly, the membrane is a crosslinked polyvinyl alcohol membrane characterized by its crosslink density. Crosslink density as used herein, is defined as percent of available alcohol groups reacted with a crosslinking agent, e.g., 5% crosslinking means that about 5% of the vinyl alcohol groups have been reacted with the chemical cross-linking agent. The membrane crosslink density ranges from about 1.0% to about 25.0%. In a preferred embodiment the crosslink density ranges from about 2.5% to about 20.0%, and most preferably ranges from about 5.0% to about 10.0%. While not fully understood, the crosslink density, as taught herein, produces a membrane that may be adapted to withstand acid environments typically encountered in petroleum processing applications such as sulfuric acid alkylation for example. The degree of crosslinking is also believed to influence the selectivity and flux characteristics of the membrane, in addition to its mechanical and structural stability. The PVA membrane is preferably crosslinked using 1,4 diisocyanatohexane before use in an acid environment. Preferably the membranes are made of crosslinked PVA, PVS and other oxoanion modified PVAs. Other suitable crosslinking agents include 1,4 diisocyanatobutane, 1,8 diisocyanatooctane, 1,12 diisocyanatododecane, 1,5 diisocyanateo-2-methyl pentane, and 4,4′ diisocyanato-diphenylmethane. In a preferred embodiment, the crosslinked PVA membrane described above is contacted with a sulfur-containing agent such as sulfuric acid, sufficient to react with the hydroxyl groups of the PVA membrane to form sulfate groups. The crosslinked polymer thereby becomes a polyvinyl sulfate membrane (“PVS”), or a copolymer of vinyl sulfate and vinyl alcohol, (“PVS/PVA”). The PVS and/or PVS/PVA membranes are suitable for membrane application in acid environments, such as sulfuric acid membrane application where acid strength may range from about 70% to about 98 wt % acid. The term “acid environment”, when used herein, means a liquid or fluid substance containing about 70% to about 98 wt % acid. In addition to poly(vinyl sulfate), other membrane materials can be poly(vinyl phosphate) and or other vinyl groups which may have affinity to sulfuric acid or an affinity to the particular acid comprising the acid environment.

In addition to the formation of polyvinylsulfate (PVS) from the reaction of polyvinyl alcohol with sulfuric acid, other inorganic oxoanion modified polymer membranes may be used. They include polyvinyl phosphate membranes made from PVA membranes.

In addition to the phosphate, one can also use arsenate, antimonate, or bismuthate to form polyvinyl arsenate, polyvinyl antimonate, and polyvinyl bismuthate, respectively. Calcogenic oxides, such as polyvinyl selenate and polyvinyl telurate, formed from the reaction of selenic and teluric acids with PVA may also be used.

Another suitable membrane is formed by reacting PVA with boric acid.

In alternative embodiments, other polymerized alcohols and their oxoanion modified compounds, referred herein as oxoanion modified polymerized alcohols may be used in the practice of the present invention. Examples of suitable polymerized alcohols include polypropyl alcohol, polybutyl alcohol, and the like. These structures also may include polymerized alcohol copolymers, polymerized terpolymers, oxoanion modified polymerized alcohol copolymers, oxoanion modified polymerized alcohol terpolymers and the like. These also would form the corresponding modified polymers.

In a preferred embodiment, the membrane is supported by a secondary membrane such as teflon or Gore-Tex™ for example, having a membrane pore size selected to compliment the pore characteristics of the primary membrane. The secondary membrane may also serve as a suitable substrate for the formation, deposition or coating of the primary membrane.

In separating acid from acid waste streams the flow rate of the feed across the membrane surface should be sufficient to prevent undue selectivity loss by concentration polarization. The flow rate of the feed depends on the particular geometry and configuration of the membrane and any supporting or containment vessel used, as well as on temperature. Generally, higher temperatures, lower flow rates can be tolerated. Establishing the optimum flow rate for a membrane configuration and set of operating conditions can be readily determined by a skilled practitioner.

High flux can be achieved by operating with the thinnest membrane that will maintain its physical integrity under the operating conditions. To help the membrane maintain its physical integrity, a composite membrane may be used. For example, a thin selective polymeric layer (or membrane) may be supported on a non-selective, highly porous membrane, to produce a laminate structure. The selective membrane layer is preferably securely attached on top of the porous membrane material which constitutes a physical support. The thin polymeric layer may range in thickness from 1 micron to 50 microns.

The membranes used in the process of the present invention may be utilized in the form of hollow fibers, tubes, films, sheets, etc. The process may conveniently be carried out in a test cell which is divided into compartments by means of a membrane or membranes. The compartments will each have means for removing the contents therefrom. The process may be carried out continuously or batchwise, but preferably in a continuous manner.

In one embodiment, the feed to a membrane unit is maintained under conditions of pressure such that substantially all of the acid is in liquid phase. The permeate may be withdrawn in a vacuum, which is generally maintained in the range of 2 to 150 mm Hg. The permeated phase will be in a vapor phase, and subsequently condensed by cooling in a condenser. This process is generally known in the art as pervaporation.

The vacuum on the permeate side of the membrane can affect both selectivity and flux. The selectivity and the flux generally increase as the vacuum pressure on the permeate increases. Higher vacuum pressure can be tolerated at higher temperatures, or with a lower boiling point acid. In yet another embodiment, a sweep gas may be passed across the membrane at a rate sufficient to increase the permeation rate. Suitable sweep gases include carbon dioxide, nitrogen, hydrogen, air, or low boiling hydrocarbons such as methane, ethane or propane.

Alternatively, the permeate side of the membrane may be swept by a liquid perstraction solvent in which the permeate is soluble and which is non-corrosive with respect to the membrane, at a rate sufficient to enhance the permeation rate of the permeable component or components through the membrane. Suitable perstraction solvents include higher molecular weight paraffins, organic acids, and compressed gases, e.g., ethane, propane, butane, etc. Especially suitable perstraction solvents are those which do not form azeotropic mixtures with any of the components of the waste acid mixture.

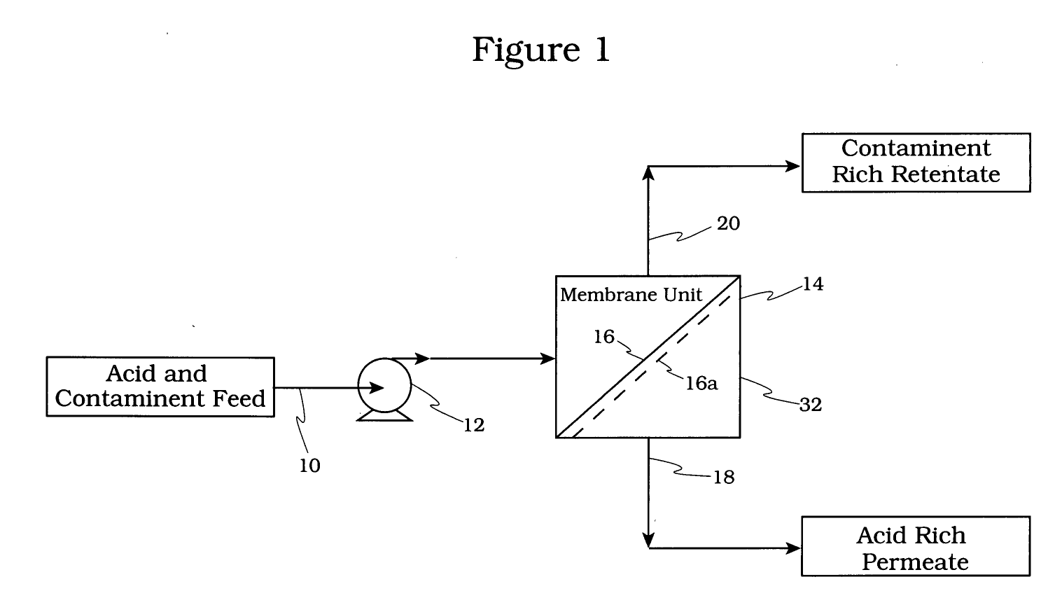

Referring now to FIG. 1, a spent acid stream 10 such as a spent sulfuric acid stream comprising acid, and contaminant such as water and hydrocarbons, is fed via a pump 12 or some other means to a membrane unit 14. The membrane unit comprises a PVS membrane 16 that is selectively permeable to acid relative to the contaminants typically present in the spent acid stream. In a preferred embodiment, membrane 16 is supported by a contiguous support membrane 16a. The selectively permeable membrane 16 separates the feed into two products, a first permeate stream 18 and a first retentate stream 20. The first permeate stream 18 has increased acid concentration and reduced contaminant content. The first retentate stream 20 has increased contaminant content. To illustrate an application of the invention, a feed that simulates four variants of an acid waste stream from a conventional sulfuric acid alkylation process was run on a single membrane embodiment as illustrated in FIG. 1. Feed versus permeate data for the four different acid feeds is shown in Table 1.

TABLE 1
DATA FOR THE EMBODIMENT OF FIG. 1
Feed Composition

| | | | | |
|---|---|---|---|---|
| Acid (wt %) | 86.0 | 88.0 | 90.0 | 92.0 |
| ASO (wt %) | 10.0 | 8.0 | 6.0 | 4.0 |
| Acid/Water Ratio | 21.5 | 22.0 | 22.5 | 23.0 |

Permeate Composition

| | | | | |
|---|---|---|---|---|
| Acid (wt %) | 89.6 | 91.4 | 93.0 | 94.4 |
| ASO (wt %) | 6.5 | 4.7 | 3.0 | 1.6 |
| Acid/Water Ratio | 22.5 | 22.9 | 23.2 | 23.4 |

The first permeate 18, referred to as the acid and water product low in hydrocarbons, may preferably contain hydrocarbons in an amount ranging from about 0 to about 7 percent by weight, preferably less than about 5 percent by weight. It may also contain acid in an amount of from about 89 to about 96 percent by weight and water in an amount of from about 3 to about 5 percent by weight.

Retentate 20, may contain hydrocarbon in an amount of from about 7 to about 30, acid in an amount of from about 65 to about 89, and water in an amount of from about 2 to about 4 percent by weight.

In a preferred embodiment, the separation mechanism is understood to be the “solution-diffusion” type. According to this mechanism feed components which have higher solubility in the polymer material get preferentially sorbed and then diffuse through the membrane to the permeate side. Separation is based primarily on sorption and diffusion.

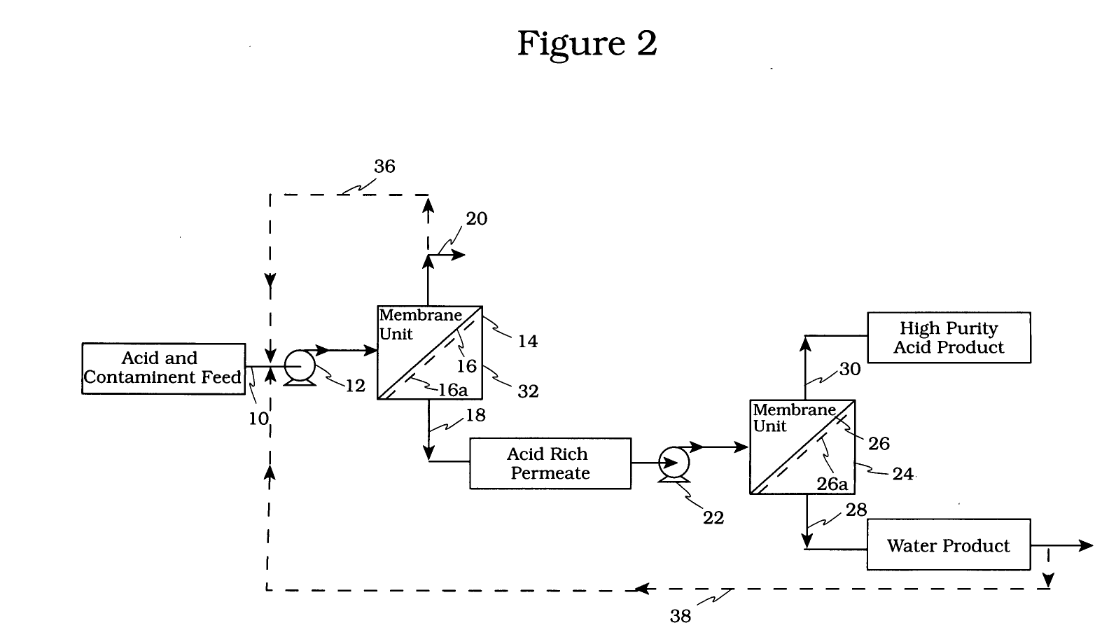

The invention further includes feeding the first permeate 18 via a second pump 22 or some other means to a second membrane unit 24, as illustrated in FIG. 2. Referring to FIG. 2, the spent acid 10 is fed to first membrane unit 14 where membrane 16 is selectively permeable to acid as described in respect of FIG. 1, or alternatively, is selectively permeable to acid and water relative to contaminants other than water such as hydrocarbons. The second membrane unit 24 comprises a membrane 26 that is selectively permeable to water over the acid. Passing the first permeate 18 through the second membrane unit 24, the membrane 26 produces a second permeate 28 and a second retentate stream 30. The second permeate is rich in water. The second retentate stream 30 is rich in acid. Membranes 16 and 26 may be preferably supported by membrane supports 16a and 26a, respectively. A calculated material balance for the embodiment of FIG. 2 is provided in Table 2. The hydrocarbon rich retentate 20 may be removed for conventional further processing, or optimally re-cycled to the feed stream, illustrated as 36. The acid and water rich permeate 18 is conventionally fed via pump 22 or other means to a second membrane unit 24. Alternatively, permeate 18 may be further processed by vacuum evaporation to remove water, or by the addition of an acid anhydride, such as SO₃, or oleum for example.

TABLE 2
MATERIAL BALANCE FOR THE EMBODIMENT OF FIG. 2

| Stream | 10 | 20 | 18 | 28 | 30 |
|---|---|---|---|---|---|
| Acid, wt % | 89.00 | 69.35 | 91.18 | 74.11 | 93.71 |
| ASO, wt % | 7.00 | 27.54 | 4.72 | 3.66 | 4.88 |
| Water, wt % | 4.00 | 3.11 | 4.10 | 22.23 | 1.41 |
| Total Flow, tons/day | 100.00 | 10.00 | 90.00 | 11.62 | 78.38 |

Preferably, the acid in the feed stream 10 may range from about 83 to about 95 wt %, ASO (or hydrocarbons) from about 2.0 to about 15 wt % and water from about 0.5 to about 4 wt %. As Table 2 shows, the first retentate 20 contains a substantially greater concentration of hydrocarbons (ASO) than the feed mixture, and the first permeate 18 contains a substantially greater concentration of acid and water than the feed mixture. A substantially greater concentration of hydrocarbons in the retentate than the feed mixture means a concentration of hydrocarbons in the retentate that is greater than the concentration of the hydrocarbons in the feed mixture by at least about 3 wt %, preferably at least about 10 wt % and more preferably at least about 18 wt %. A substantially greater concentration of acid and water in the permeate than the feed mixture means a concentration of acid and water in the permeate greater than the concentration of acid and water in the feed mixture by at least about 1 wt %, preferably at least about 3 wt %, and more preferably at least about 6 wt %.

Also, Table 2 shows that the second retentate contains a substantially greater concentration of acid than the first permeate, and the second permeate contains a substantially greater concentration of water than the first permeate. A substantially greater concentration of acid in the second retentate than the first permeate means that the concentration of acid in the second retentate is greater than the concentration of the acid in the first permeate (i.e., the feed mixture to the second membrane) at least about 1 wt %, preferably at least about 3 wt %, and more preferably at least about 6 wt %. A substantially greater concentration of water in said second permeate then said first permeate means that the concentration of water in said second permeate is greater than the concentration of water in said first permeate at least about 3 wt %, preferably at least about 10 wt %, and more preferably at least about 18 wt %.

In the embodiment of FIGS. 1 and 2, the membranes 16 and 26 are preferably operated at conditions of temperature and pressure sufficient to maintain the acid in the liquid phase, e.g., temperature in the range of about −10° C. to about 300° C., more preferably from about 0° C. to about 50° C., and most preferably from about 4° C. to about 40° C. Preferably, membrane 16 is operated from about 100 to about 5000 psig, more preferably from 800 to 1200 psig on the feed side. The pressure on the permeate side is typically atmospheric pressure, but it could be operated at higher pressure so long as the pressure difference across the membrane is sufficient for permeation purposes. Membrane 26 is preferably operated in pervaporation mode with the feed pressure typically atmospheric and the permeate side under vacuum. The water containing product 28 (second permeate) may preferably contain greater than about 4 percent by weight water, less than about 10 percent sulfuric acid. The high purity acid product 30 (second retentate) may preferably contain greater than about 91 percent by weight sulfuric acid, less than about 10 percent by weight hydrocarbons and less than about 3 percent by weight water.

In one embodiment of the present invention shown in FIG. 2, a portion of the first retentate 20 and/or the second permeate water 28 may be recycled (illustrated by dashed line 36 and 38) to the feed waste acid stream 10 for further processing. Also, it should be understood that more than one membrane units can be used in series and/or parallel configurations for each stage of the separation process. In the first stage one or more membranes 16 that are permeable selective to acid and water over the hydrocarbons of the spent acid feed stream 10 can be used. The number of membranes in each stage will depend on a number of factors including the desirable purity of the permeate product in each state, the composition of the feed, the type of the polymeric membrane or membranes used and the process conditions under which the membranes are operated.

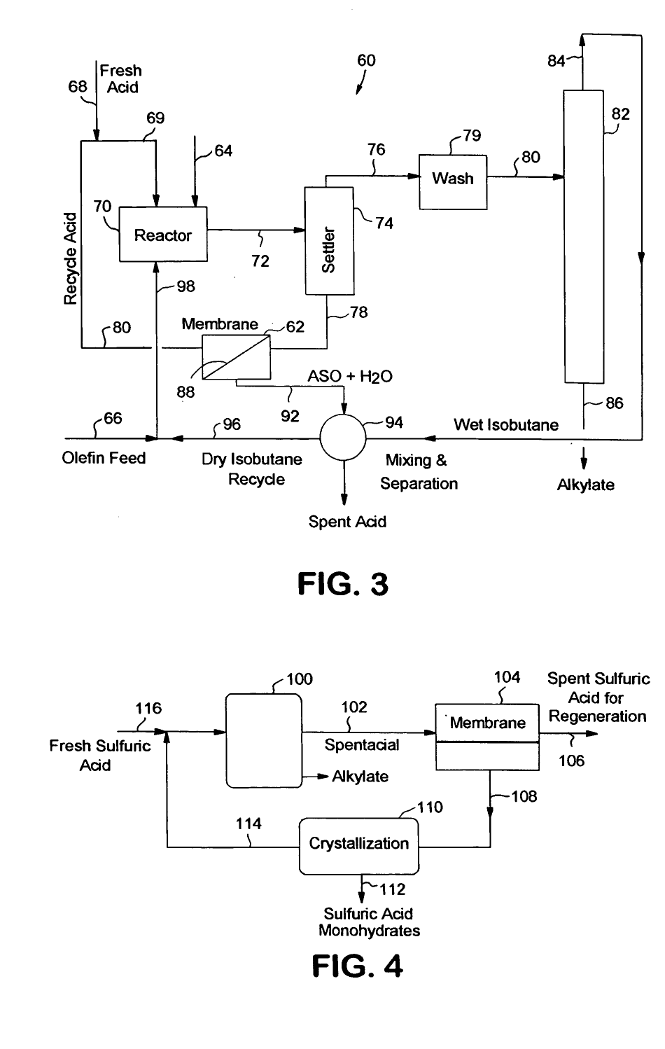

One advantage of the present invention may be appreciated by reference to an improved alkylation process for the manufacture of higher octane gasoline blending component, the improvement residing in the use of membranes to regenerate the spent acid. Referring now to FIG. 3, the invention is illustrated embodied in an improved alkylation process 60. The alkylation process includes at least one membrane separation unit 62 for controlling both the acid soluble oil (“ASO”) and water concentrations in the alkylation process 60.

More specifically, a fresh isobutane stream 64 is fed to a reactor 70 where it is reacted with olefins 66 such as butenes in the presence of an acid catalyst 69 such as sulfuric acid. The alkylation product 72 from reactor 70 is transferred to a settler 74. Settler 74 separates the alkylation product into a spent acid stream 78 and hydrocarbon stream 76. The strength of the spent sulfuric acid stream 78 is reduced because of moisture and ASO material generated due to undesirable side reactions in the alkylation reactor 70. The hydrocarbon stream 76 from settler 74 is transferred to a wash unit 79 where it is caustic and water washed. Then via line 80 it is transferred to a fractionation column 82 to recover an alkylate stream 86 and an overhead stream 84. The overhead stream 84 contains mainly isobutane with some small amount of propane and n-butane.

The isobutane stream 84 contains soluble water picked up in the caustic and water wash. Of course, water is an undesirable component of the alkylation process, as it dilutes the sulfuric acid strength in addition to causing corrosion problems. The spent acid stream 78 from settler 74 is directed to a membrane unit 62 to remove ASO and water. An ASO rich spent acid stream 92 is then used to reduce the water concentration in the recycled isobutane stream 84 by contacting the two streams in unit 94 so that the water dissolves in the spent acid phase. A dry isobutane recycle stream 96 is mixed with the olefin stream 66 and then transferred to said reactor 70 via line 98. It is also possible to feed stream 66 and stream 96 separately to reactor 70.

This invention reduces the water and ASO concentrations in the alkylation process acid stream, maintaining acid strength in the alkylation process, which in turn maintains or increases the alkylation efficiency, and helps to enhance the octane value of the alkylation product. This process will also reduce the cost of sulfuric acid regeneration by reducing the total amount of spent acid shipped for regeneration.

Yet another embodiment of the present invention includes a crystallization step to remove water from the recycled spent acid, as shown in FIG. 4. A membrane unit 104 is used as explained above to remove ASO from a spent acid stream 102 of an alkylation process 100. The ASO lean stream 108 is then chilled in a crystallization unit 110 to crystallize sulfuric acid monohydrates to remove water from the recycled spent acid stream via stream 112. Stream 114 is recovered sulfuric acid send back to the alkylation process. In a variation of this embodiment crystallization could be replaced with an adsorber unit (not shown) to remove water from stream 108.

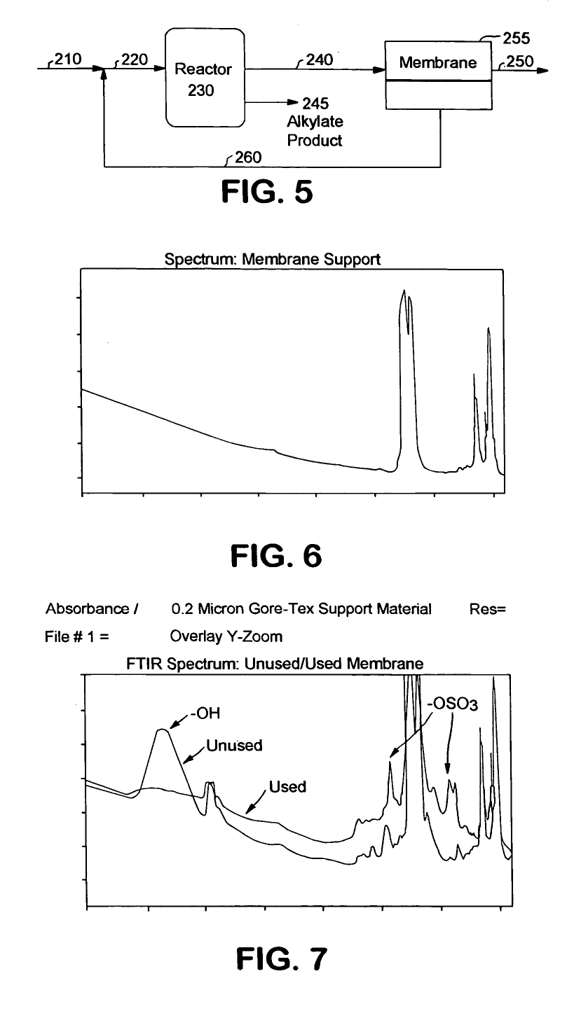

In yet another embodiment shown in FIG. 5, a SO₃ and/or oleum stream 210 is mixed with a membrane separated sulfuric acid stream 260 prior to sending the treated sulfuric acid to the alkylation unit 230. The addition of SO₃ and/or oleum reduces the water concentration in the treated sulfuric acid stream 260 resulting in an increase in acid strength in the sulfuric acid stream 220 which in turn helps to enhance the octane value of the alkylation product 245. Spent acid 240 is passed through at least one membrane unit 255, as explained above, to produce a first stream 250 higher in ASO concentration and which is sent to a conventional spent acid regeneration facility and a higher strength sulfuric acid stream 260 which is recycled to the alkylation reactor. An example of a material balance for the various streams of the embodiment of FIG. 5 is provided in Table 3.

TABLE 3
MATERIAL BALANCE EMBODIMENT OF FIG. 5

| | 210 | | | 240 | | |
|---|---|---|---|---|---|---|
| Components | Oleum | 220 | 230 | Spent Acid | 250 | 260 |
| Acid (wt %) | 97.15 | 94.50 | 0 | 86.57 | 80.02 | 91.12 |
| Water (wt %) | 0 | 1.93 | 16.82 | 3.18 | 2.94 | 3.35 |
| SO₃ (wt %) | 2.85 | 0 | 0 | 0 | 0 | 0 |
| ASO (wt %) | 0 | 3.50 | 83.13 | 10.24 | 17.04 | 5.53 |
| Total (MeT/Day) | 33.50 | 94.17 | 8.63 | 102.8 | 42.13 | 60.67 |

The invention will be further illustrated by the following examples.

### EXAMPLES

### Example 1

0.9 g of polyvinylalcohol (PVA) was dissolved into a 50/50 mixture of dimethylsulfoxide (DMSO) and dimethylforamide (DMF). In this particular example, PVA was added to a 15 g/15 g DMSO/DMF solvent mixture. The PVA (Aldrich Chemical Co.) was 99% hydrolyzed and had a molecular weight between 124-186 Kg/mol. The solution was subsequently heated to 80° C. for approximately 5 hours. The solution was then cooled to 10° C. and mixed with 0.084 g of hexamethyldiisocyanate dissolved in a 2.5 g DMSO/2.5 g DMF mixture (also cooled to 10° C.). The solution visually became more viscous due to the reaction of the PVA and the diisocynanate. After approximately 2-3 minutes, the 2.7 wt % solution was cast onto a 0.2 micron pore size Gore-Tex substrate using conventional casting knife procedures. This solvent system was selected due to its favorable solubility characteristics and its corresponding chemical inertness.

The Gore-Tex substrate was placed on a support glass plate. The solution of PVA and crosslinking agent was knife coated on top of the support. The coating was first dried overnight (room temperature) under a continuous flow of nitrogen gas. Further drying was performed by thermal treating the membrane in a vacuum oven at 130° C. for 5 hours to ensure completion of the crosslinking reaction (approximately 5%) as well as to ensure complete evaporation of the solvent. The dried membrane was next tested with a spent acid solution in Sepa®ST membrane cell from Osmonics at 24° C.

The feed was pressurized to 700 psig, and permeate pressure was at atmospheric pressure. Feed and permeate streams were analyzed for compositions. Initial permeate rate was 1.83 kg/hr/m².

First Test

| | Spent Acid Solution | Permeate |
|---|---|---|
| Components | Feed Composition | Composition |
| Acid (wt %) | 89.2 | 91.6 |
| Water (wt %) | 4.4 | 5.4 |
| Acid Soluble Oil (wt %) | 6.5 | 3.0 |
| (or Hydrocarbons) | | |

Second Membrane Tested at 300 psig feed pressure and atmospheric pressure permeate, gave an initial flux of 3.6 kg/hr/m². Feed and permeate compositions are reported below.

| | Spent Acid Solution | Permeate |
|---|---|---|
| Components | Feed Composition | Composition |
| Acid (wt %) | 87.8 | 90.8 |
| Water (wt %) | 4.1 | 4.7 |
| Acid Soluble Oil (wt %) | 8.1 | 4.5 |
| (or Hydrocarbons) | | |

The synthesis procedure described in this example can be used for forming crosslinked polyvinylalcohol membranes and other hydroxyl-containing polymers and copolymers, e.g., copolymers of vinylacetate and vinylalcohol membranes for use in separation of ASO from sulfuric acid in the alkylation process. Several parameters that can be controlled are as follows:
(1) The degree of crosslinking, i.e., pore volume, can be controlled by the addition of a predetermined amount of the crosslinking agent, such as diisocyanates.
(2) The chemical structure of the crosslinking agent determines the physical (e.g., membrane mechanical properties) and chemical properties (e.g., interaction with the feed stream). The structures of the diisocyanates useful in this invention exemplifies the wide range of potential crosslinking agents (O═C—N—R—N═C═O, where R can be aliphatic and/or aromatic in nature). The structures of the diisocyanates useful in this invention includes mixtures and blends of aliphatic and/or aromatic diisocyanate structures.
(3) The control of the polar/nonpolar characteristics can be controlled via the proper selection of the amount and structure of the crosslinking agent and the structure of the polymer or copolymer. The level of hydrogen-bonding in the crosslinked network is a direct function of the extent of crosslinking, i.e., amount of vinyl alcohol units.

### Example 2

The reaction of the sulfuric acid with a crosslinked (with 1,6 diisocyanatohexane) poly(vinyl alcohol) (PVA) membrane was followed with FTIR. The reaction took place by placing the crosslinked PVA membrane into a spent sulfuric acid fluid. The thickness of the original membrane, as determined by SEM (shown in FIG. 12), was approximately 15 microns. The results are shown in the spectra of FIGS. 6 and 7. The spectrum of FIG. 6 shows the absorbance of a teflon membrane support having a nominal pore size of 0.2 microns, while the spectrum of FIG. 7 shows the initial and used Gore-Tex supported PVA membrane, respectively. The spectra show that loss of the alcohol group occurred, which was “replaced” with a sulfate moiety.

### Example 3

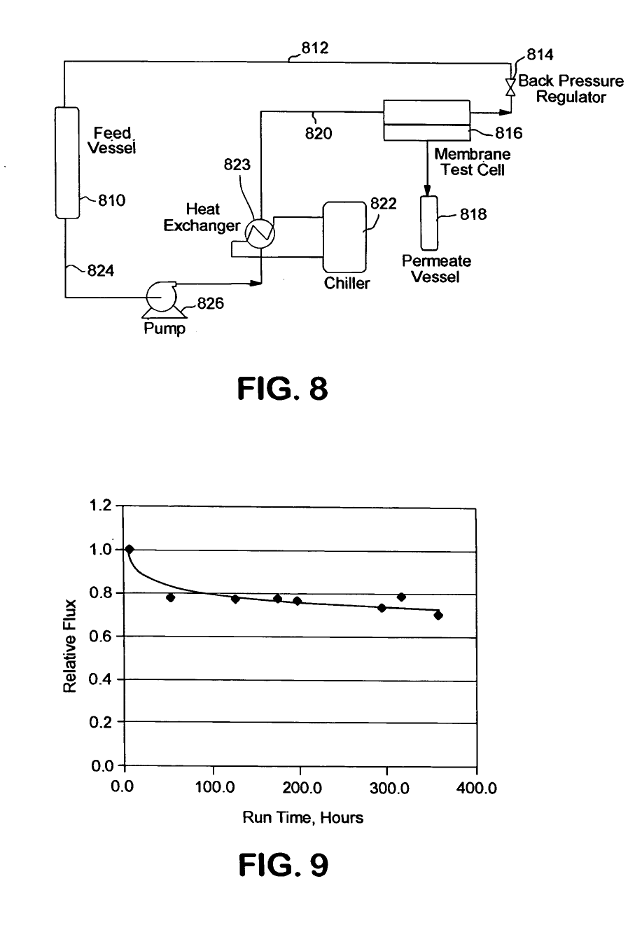

The schematic of FIG. 8 shows a membrane testing system which was used to evaluate the membranes. In reference to FIG. 8 the conditions used in the evaluation were:
Feed Vessel 810, Volume: 3000 ml
Pump 826, Rate: up to 1 gallon/minute (usually run at 0.63 gallons/minute)
Heat Exchanger 824: 1.5″ diameter and 18.75″ length, 2.18 ft² surface area
Membrane 816, Effective Surface Area in Use: 24 in²
Membrane 816, Maximum Operating Pressure Test Cell: 1000 psig
Chiller 822 to Maintain Desired Feed Temperature

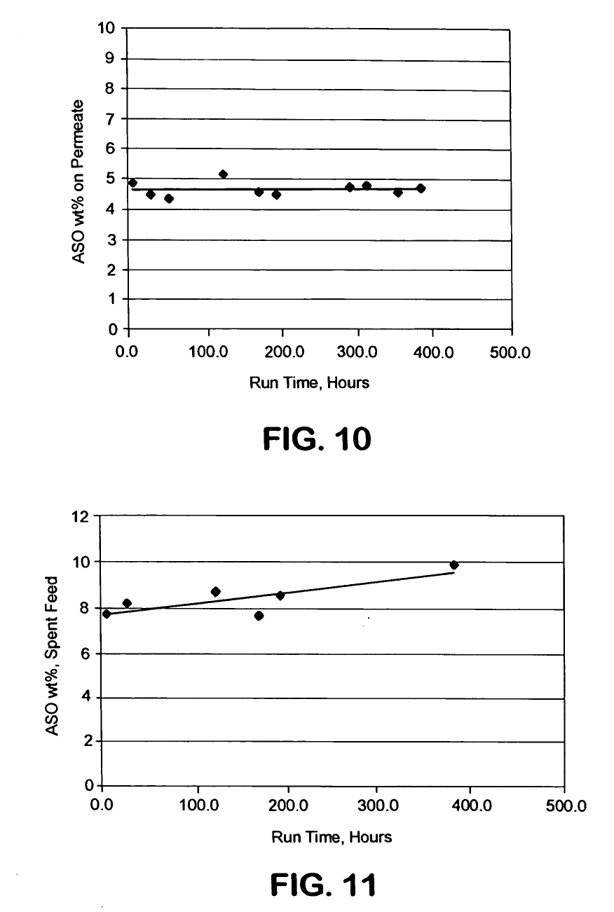

In operation to maintain a given temperature, heat exchanger 823 is operatively connected to a chiller 822. The spent acid is directed via line 820 to a membrane cell 816. The permeate which is rich in acid and water is collected in a permeate vessel 818. The retentate rich in hydrocarbons is recycled via back pressure regulator 814 and line 812 to the feed vessel 810. The permeate and retentate are analyzed for acid, water and hydrocarbon concentration using well known techniques. The results of the measurements at 500 psig feed pressure and 20° C. are presented in FIGS. 9, 10 and 11. FIG. 10 shows the relative flux of the permeate through membrane 816 as a function of time. FIG. 10 shows the ASO concentration in the permeate as a function of time. FIG. 11 shows the ASO concentration in the feed with run time. Thus, comparison of FIGS. 10 and 11 shows that ASO concentration in the permeate is substantially lower than the feed concentration. The data show that after a period of membrane conditioning, the ASO is concentrated in the feed due to the separation by the membrane of sulfuric acid and water from feed stream. The membrane continued to produce permeate containing approximately 50% of feed ASO concentration even over extended periods of time of continuous testing.

The above preferred embodiments are provided for purposes of illustrating the invention and should not be construed as limiting the scope of the invention as delineated by the following claims.

1. A method for recovering acid from a feed mixture comprising acid, hydrocarbons and water, the method comprising:
processing said mixture using a crosslinked polymeric membrane to form a first retentate containing a substantially greater concentration of hydrocarbons than said feed mixture and a first permeate containing a substantially greater concentration of acid and water than said feed mixture, said polymeric membrane being selectively permeable to the acid and water over the hydrocarbons in the feed mixture and further characterized as having a crosslinking density from about 1.0% to about 25.0%.

2. The method of claim 1 wherein said polymeric membrane is crosslinked PVA, PVS, crosslinked PVS or a combination thereof.

3. The method of claim 1 wherein said feed mixture contains from about 70 to about 98 percent by weight sulfuric acid strength acid.

4. The method of claim 1 wherein said feed mixture contains from about 70 to about 98 wt % sulfuric acid, from about 1 to about 20 wt % hydrocarbons, and from about 0.5 to about 7 wt % water.

5. A method for making an acid tolerant polymeric membrane comprising:
(a) forming a crosslinked polyvinyl alcohol membrane,
(b) exposing the membrane to a sulfating agent sufficient to sulfate substantially all the membranes hydroxyl groups.

6. The method of claim 1 wherein said membrane comprises the following copolymer: 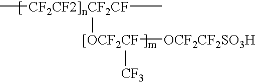
where m=5 to 13.5; and n=1,000.

7. A polymeric membrane for separating hydrocarbons from a spent sulfuric acid mixture comprising sulfuric acid, hydrocarbons and water, said polymeric membrane comprising:
a porous support; and
a thin polymeric selective layer contiguous to said porous support;
wherein said polymeric membrane allows preferential permeation of sulfuric acid, over hydrocarbons.

8. The polymeric membrane of claim 7 wherein said polymeric layer is made of a polymer selected from the group consisting of PVA, PVS, PVA phosphate, PVA arsenate, PVA selenate, PVA tellurate, PVA nitrate, and PVA borate.

9. The polymeric membrane of claim 7 wherein said polymeric layer is crosslinked to enhance its mechanical and chemical stability.

10. The polymeric membrane of claim 7 wherein said polymeric layer comprises PVA, PVS, polypropyl alcohol, polybutyl alcohol or a combination thereof.

11. An acid tolerant polymeric membrane comprising a crosslinked polyvinyl sulfate polymer, a crosslinked co-polymer of polyvinyl alcohol and polyvinyl sulfate, or a combination thereof, that can withstand an acid environment.

12. The membrane of claim 11 further characterized as having a crosslinking density ranging from about 1.0% to about 25.0%.

13. The membrane of claim 11 wherein the crosslinking density ranges from about 2.5% to about 20.0%.

14. The membrane of claim 11 wherein the crosslinking density ranges from about 5% to about 10%.

15. The membrane of claim 11 wherein the polymeric membrane is crosslinked with a crosslinking agent comprising:
(a) aliphatic diisocyanate
(b) non-aliphatic diisocyanate
(c) mixtures of (a) and (b)
(d) blends of (a) and (b)
(e) combinations of (c) and (d)
